(19) United States
(12) Patent Application Publication
(10) Pub. No.: US 2012/0213926 A1
(43) Pub. Date: Aug. 23, 2012

(54) METHOD FOR PRODUCING A FILTER ELEMENT HAVING A FILTER MEDIUM

(76) Inventors: Viktor Josef Lauer, Nalbach (DE); Daniel Kleemann, Saarbrucken (DE); John Kazimierz Duchowski, Saarbrucken (DE); Frank Oberli, Eglisau (CH)

(21) Appl. No.: 13/261,209

(22) PCT Filed: Sep. 7, 2010
(86) PCT No.: PCT/EP10/05474

§ 371 Date: May 2, 2012

(30) Foreign Application Priority Data
Sep. 12, 2009 (DE) 10 2009 041 401.0

(51) Int. Cl. B05D 5/00; B05D 3/12; B05D 1/02

(52) U.S. Cl. 427/244

(57) ABSTRACT

The invention relates to a method for producing a filter element (1), comprising a first filter medium (2), which has individual filter folds (4), and a second filter medium, which surrounds at least sections of the filter folds (4) in the manner of a mat-like filter jacket (6) that is composed of individual fibres (5). The invention is characterised in that, in order to form the individual fibres (5), a solid base material is converted into a melt that, with the addition of a fluid carrier flow in directed fibre form, is injected into or sprayed onto the first filter medium (2) via at least one nozzle device (8) in such a way that the individual fibres (5) solidify at least after contacting the first filter medium (2) to form the filter jacket (6), and in that, for a successive mat build-up of the second filter medium (6) during the fibre application, the relevant nozzle device (8) and the pleated first filter medium (2) perform a relative movement with respect to each other and/or the nozzle device (8) applies the fibres along the outer contour of the first filter medium (2) in specifiable spray or injection directions.

The invention relates to a method for producing a filter element having a first filter medium, which has individual filter folds, and a second filter medium, which surrounds the filter folds at least in regions in the manner of a mat-like filter jacket that is composed of individual fibers.

A filter element of this type with a first filter medium in the form of a filter material which has individual filter folds, folded in a star shape, and with a second filter medium in the form of a support means is disclosed in DE 10 2005 014 360 A1. The support means extends at least in part into the space between two adjacent filter folds and/or on the inner peripheral side and/or outer peripheral side to the filter folds and is made fluid-permeable. The respective support means is provided with filter-active substances or itself is built up from these filter-active substances so that the second filter medium is used to reduce the effect of fluid components which reduce the service life, such as specific aging products or other media which damage the fluid.

The indicated filter-active substances are used as a type of particle scavenger and can hinder a migration of the damaging substances to the clean side of the filter element, for example, in the bonding with a foam-like body as the support means which keeps the filter folds in position. The support means is made from a porous, especially sponge-like base structure as the basic matrix, where, due to the inherent elasticity of the base structure, the outer filter folds meshing with the foam material and convexly protruding projections of the support means mesh with the existing spaces between adjacent filter folds of the filter material. The support means can be built up out of so-called bicomponent fiber systems by means of a melting process. The support means or second filter medium is produced independently of the folded filter material or the first filter medium and is then arranged around the latter. The support means is in the form of a matrix of self-bonding plastic fibers and/or natural fibers which are at least partially fibrillated.

A method for producing a filter element with a filter medium which has folds which follow one another in at least one surface region is disclosed in DE 602 11 579 T2. In the known method, a filter is configured by depositing spun fibers in a semimolten state on a mold, with the filter encompassing the mold of one filter part, the mold encompassing a filter section mold surface for forming a filter section, and a frame which encloses the filter section mold surface. In doing so, the nonwoven in the form of fibers with an essentially constant thickness is deposited on the mold section so that the corresponding filter section of the filter is formed from the nonwoven; i.e., the fibers and the grid of the mold section. The fibers which have been deposited on the frame and the grid of the mold section fuse with one another, as a result of which the nonwoven is obtained and the contour of the filter part characterized by folds is formed. The mold of the grid can have a bellows shape or the shape of a sinusoidal curve. Fibers projecting out of the frame are folded in the direction of the inside of the frame and are attached to the frame.

WO 2009/088647 A1 relates to a method for producing a filter element with a two-layer filter medium. The fluid filter medium has a first layer of microfibers which have an average diameter of at least 1 μm and a second layer of submicrofibers which have an average diameter of less than 1 μm, with at least one of the fiber groups being oriented and the two layers being adjacent to one another. In production, the two layers are first produced independently of one another, in particular provided with the desired orientation of the fibers, and then placed together. The fluid filter medium can be designed in the shape of a tubular cylinder with concentrically arranged filter layers. The second, especially inside layer can be folded up in a star shape.

DE 101 09 474 C1 proposes a method for producing nonwovens in which nanofibers and/or microfibers are produced by an electrostatic spinning method from a polymer melt or a polymer solution and are deposited into a nonwoven, with a web-shaped backing material being located or routed through between at least two spray devices made as electrodes for producing an electrical field and each side of the backing material being coated with the nanofibers and/or microfibers produced by means of the spray devices and having opposite polarity. A nonwoven produced using this method can be used as the filter material.

In systems and units in which fluids are used as working media, the operational reliability depends largely on the proper composition of the pertinent fluids. In particular for higher grade units, it is therefore necessary for economic reasons, for the media under consideration, whether gaseous media or fluids, to provide suitable filter devices in order to control impurities which occur in operation. When pertinent operating fluids such as lubricating oils, fuels, and hydraulic liquids, but also industrial process water as well as air flows, are contaminated with impurities that contain colloidal impurities or those present as solid particles, especially high demands must be imposed on the efficiency of the filter devices.

The use of filter mats is known which are folded or pleated at least in surface regions, which are composed or different filter materials, which are wrapped around a solid support pipe provided with passages and located within the filter element, and which are enclosed as protection against damage from the outside in a fine-mesh wire gauze which follows the orientation of the fibers of the fiber mat. Joining of the filter mat to the indicated wire gauze is complex and thus expensive, and moreover the filter mat is not completely protected against damage. The known wire gauze can accommodate only small forces so that the filter element can possibly swell and become unusable as soon as the incident flow direction, for example, in a backflow process from the inside to the outside, is reversed. Since the wire gauze is directly in contact with the outer layer of the filter mat, a resistant material should be chosen for this purpose in order to prevent damage of the filter mat from occurring, however, with this resistant material not having such good passage and filtration properties, such as, for example, sensitive filter materials of a polyester nonwoven, glass fiber nonwoven, or paper web.

It is also desirable to connect a prefilter medium upstream of the pleated filter medium. This is possible only to a limited degree using these wire gauzes with a relatively large mesh width, and there is the risk that, for example, metal shavings and other fouling can also damage the sensitive filter medium and can have a major adverse effect on the filtration performance. WO 01/37969 discloses wrapping a fixing tape, for example, in the form of an adhesive tape, around the pleated filter medium in order in this way to stabilize and fix the individual filter folds in their definable distance to one another in order to maintain the full filter surface required for filtration. A prefiltration, however, is not possible using this known solution.

Based on this prior art, the object of the invention is to make available an economical, suitable method for producing a filter element with a filter medium, which has successive folds at least in one surface region and is easily fixed in its position for all operational requirements and/or can be implemented with at least one prefiltration.

This object is achieved according to the invention by a method having the features specified in claim 1 in its entirety. A production of a technically simple type of arrangement and application of a fiber composite, which stabilizes the first filter medium with its filter folds in any phase of operation, is devised in that, to form the individual fibers, a solid base material is converted into a melt which is sprayed or injected onto the first filter medium via at least one nozzle device with the addition of a fluid transport flow in a directed fiber form such that the individual fibers set at least after contacting the first filter medium with the formation of a filter jacket and in that, for a successive jacket build-up of the second filter medium during the fiber application, the respective nozzle device and the pleated first filter medium execute a relative movement to one another and/or that the nozzle device applies the fibers along the outside contour of the first filter medium in definable spray or injection devices.

Advantageously, the fibers are applied to the filter medium such that the applied fibers keep the folds in their position and/or form a prefilter or afterfilter stage for the filter medium. The fibers can be applied with the formation of at least one fiber material web between the folds and in this way can keep the folds in their position in the operation of the filter element.

By the fibers preferably being applied over the entire surface of the filter medium which defines the effective filter area of the filter element, an effective prefilter or afterfilter stage is moreover provided as a function of the direction of flow through the filter medium. The filter thickness of the prefilter or afterfilter stage formed in this way can be continuously adjusted in almost any manner by the applied layer thickness of the individual fibers. Even a layer thickness which varies over the surface of the filter medium is enabled by the application of fibers according to the invention to the filter medium. In this way, an economical production of a filter element which meets the respective customer requirements with an extremely resistant structure, especially with respect to its incident flow side, is devised.

Optimized filter elements can be produced matched individually to the respective application and the flow conditions, especially on the incident flow side of the filter element and, with respect to the force conditions prevailing there, by the alignment of the fibers which can be freely chosen structurally in a wide range on the filter medium and relative to the filter folds.

The application of individual fibers according to the invention, associated with bringing the individual fibers into contact with the filter folds of the filter medium in a positive and/or non-positive and/or adhesive manner, is outstandingly well suited to stabilization of the individual filter folds, especially of filter folds which are aligned in the axial direction, for cylindrical and oval filter elements. If the individual filter folds are kept in their position by the individual fibers in a stabilizing manner, they cannot inadvertently come into contact with one another during the filtration process; this would otherwise reduce the effective filter area. Consequently, a filter element produced according to the invention is also used to keep the desired filter performance constant.

The fixing of folds, however, can also be omitted, and the applied individual fibers, depending on the direction of flow through the filter element, can form a prefilter or afterfilter stage with correspondingly altered filter finenesses compared to the primary filter layer in the form of the filter medium with the filter folds. It is also possible, viewed in the direction of flow through the filter element, to place a prefilter stage upstream of the filter folds and to connect an afterfilter stage with the individual fibers on the opposite side. In this way, viewed in the throughflow direction of the medium which is to be filtered, starting from a coarse filtration of the prefilter stage, a primary filtration through the filter medium with the filter folds can be connected downstream, and afterwards fine filtration can be undertaken via the afterfilter stage. In this respect, a selectivity of the entire filter element can be freely chosen by way of the individual fibers, and the individual fibers can be arranged to one another such that in any case fluid-permeable interspaces are created and are used for passage of the media or fluids.

It has proven especially advantageous to apply the fibers in a production process during a rotational movement around a longitudinal axis of the filter element on the filter element by a device which is suitable for this purpose and thus to apply the fibers to the pleated filter medium. In this respect, the filter jacket can be formed for purposes of prefiltration.

In the choice of a suitable fiber material, especially in the form of a thermoplastic, it is possible to apply the fibers in a molten or liquefied state of the plastic to the free ends of the filter folds of the filter medium from the outside. After cooling or setting of the fiber material, a shrinkage process which occurs here can be used to fix the fibers to the edges and interspaces of the filter folds not only by adhesion, but also by a residual radially acting force component of the tensile force which is caused by the shrinkage process, which component arises in this process. The force which is directed radially with reference to a cylindrical pleated filter medium yields a certain penetration of the fibers or the homogenous filter jacket which has been formed by the fibers between the individual filter folds. Furthermore, this causes a fiber material web between the filter folds which constitutes an extremely resistant spacer for the filter folds and keeps the filter folds in their position in a clearly improved manner compared to the devices known from the prior art for positioning and fixing of filter folds.

Another decisive advantage of a filter element produced according to the invention is that the fibers are able to form a seamless layer or a seamless filter jacket for blanket application to the filter medium, since it is very thin due to its adjustable fiber thickness and thus can be applied in several layers in the manner of a continuous application. In this respect, no joining technique is necessary besides the connections of a prefilter material which are provided otherwise onto the primary filter stage of a filter element, as is shown to some extent in the prior art.

Moreover, in this way, it is also possible to change the filter fineness, for example, by the chosen fiber density over the entire wall thickness of the fiber jacket. In this context, it is advantageously provided that the fiber jacket is used as a prefilter, based on the filter fineness of the folded filter medium, with the former being selectively changed from a high filter fineness to a lower filter fineness to the outside, as a result of which larger filter parties are filtered out on the respectively incident flow-side of the fiber jacket than, for example, in deeper layers of the fiber jacket which are closer to the pleated filter medium. The individual fibers can be arranged especially advantageously at an angle to the longitudinal axis of the cylindrical filter element or to the longitudinal axis of the folds of the filter medium from roughly 20° to 90°, it being feasible to apply the fibers transversely to the filter medium in terms of their longitudinal alignment, that is, at an angle of roughly 90° to the longitudinal axes of the folds. It is especially advantageous to change the fiber orientation for fibers which have been applied by means of a winding process such that the fibers cross one another, for example, in their alignment over the entire layer thickness of the fiber jacket. It can also be advantageous to arrange the fibers similarly to a chaotic alignment, as is known of pressed filter mats.

As already described, the fibers can be essentially applied on all sides of a filter medium, but especially on the filtrate side and/or the unfiltered material side of a filter medium. It has been shown surprisingly to one with average skill in the art in this field that even at small layer thicknesses of a fiber application according to the invention, roughly starting from a thickness from 1 mm to 2 mm, an excellent fixing of filter folds of a filter medium can be achieved. Depending on the intended application of the filter element, it can be quite useful to provide fiber layer thicknesses up to roughly 6 mm or more on the filter medium.

Fundamentally, the filter fineness of the fiber jacket can be freely selected, but it is advantageous to make the filter fineness greater than in the filter medium surrounded correspondingly with the fiber jacket in order to achieve a useful prefilter stage in the manner of a coarse filter for a gaseous or liquid medium.

Depending on the material properties of the base material of the fibers, a cement connection to the folds of the filter medium takes place in a fiber application, especially a cement connection in the form of a hot-melt cementing. The latter is especially the case when the base material of the fibers must be heated for liquefaction and for formation of fanning into laminae with subsequent fiber formation.

The fiber layer, in addition to its mechanical filter action, can be imbued with one or more other functions, such as, for example, a definable electrical polarity, a chemical and/or physical preference for certain substances which are to be filtered, or the like, by certain fiber materials being chosen or corresponding additives, which can also have antibacterial properties in the field of pharmaceutical use, being added to the base material.

Methods for filtering solid suspended matter out of fluids by means of filter media are often based on the use of auxiliary filter devices or supplementary filter agents in order to prefilter the fluid mixture, which is generally based on a liquid, and to prolong the operating life of a filter element. The application of individual fibers according to the invention to a predefined filter medium is especially ideally suited to applying and/or embedding supplementary filter agents on the top of the fiber jacket or also during application of the fibers. This intrinsic application method can prevent a tightly packed layer of dirt or a filter cake of solid material from settling on the surface of the fiber jacket or filter element and in this way adversely affecting the effectiveness of the primary filter stage in the form of the filter medium.

In these settling processes, essentially two types of suspended matter can be distinguished, specifically deformable and nondeformable suspended matter. Auxiliary filter devices work for nondeformable suspended matter by increasing the total porosity and thus the loading capacity of the filtration system. In addition, supplementary filter agents slow the passage of nondeformable solids on the surface of the filter media where they then can easily penetrate into the pore structure and can block the passage of the liquid. Furthermore, auxiliary filter devices interrupt the formation of the packed solid layer or of the filter cake. Auxiliary filter devices are therefore less effective in the separation of nondeformable suspended particles compared to deformable suspended particles.

Staggered filter beds, for example, of glass microbeads or nonspherically shaped supplementary filter agents such as porous materials with low density can be applied into the fiber jacket, for example, in the form of silicates, oxides, carbonates, silica gel, polymers, or other porous substances with low bulk density. Other supplementary filter agents can consist of activated charcoal or can be formed from ion exchanger resins, antioxidant additives, etc.

One version of the method according to the invention for producing the filter element calls for at least the following further method steps:

Liquefaction of a base material of the fibers which may be in the solid state;

Delivery of the liquid base materials for the fiber production, preferably under pressure, into an injection or spray device for forming a jet which fans out into jets or laminae and which breaks down as the thickness is reduced into the desired fibers and then is applied to a prepositioned filter medium or a number of filter media.

The injection method manages without further input of kinetic energy, except for the hydraulic pressure, to the liquid base material for the fibers, while in a spray method, additional kinetic energy is applied to the liquid jet for further fanning and thickness reduction and for accelerated transport of the fibers which are forming by alignment of the molecules in the base material and by crystallizing out.

In one preferred method, a base material which is present, for example, as a granulate for the fibers is heated and liquefied and is delivered with an extruder device to an injection or spray device, especially to a hydraulically atomizing nozzle, and atomized. The nozzle for forming the fibers can also be a multicomponent nozzle, especially a two-fluid nozzle which delivers a transport air flow to the base material melt, with the liquid base material within the nozzle body or outside the nozzle body being combined with the transport air flow for purposes of atomization of the liquid base material and of the transport to the filter medium.

Preferably, thermoplastics or also single-component or binary duroplastics are suitable as the base material for the fibers. Furthermore, so-called bicomponent fibers with a definable staple length can be used for the fiber material.

One especially preferred production method for a fiber jacket according to the invention is a so-called “spunspray” method in which a solid base material for the fibers, for example, a thermoplastic, is first converted from a preferably granulate form into a melt. The melt is supplied by the extruder device to the two-fluid nozzle in whose one central channel the melt can be delivered. The central nozzle channel is surrounded by an annular channel for transport air, the transport air which can also be heated, or a hot gas being routed to the melt flow on a common exit surface of the nozzle. In the process, the molecules of the base material which are first present chaotically in the melt are aligned and define a fiber form which crystallizes after contact with the filter medium and sets as it shrinks. Instead of the transport air as the fluidic transport flow, some other working gas, such as nitrogen, or even a liquid medium can also be used.

The filter medium in the form, for example, of cylindrical filter folds which are folded in the longitudinal direction is kept in rotation in the injection or spray region of the two-fluid nozzle, which then moves back and forth in the longitudinal direction of the filter medium and in this way produces a fiber jacket with a successively increasing layer thickness on the pleated filter medium. This application nozzle can also be stationary, and the filter medium can at the same time move back and forth in the longitudinal direction as it rotates.

The cooled and trimmed fiber jacket can be imprinted with pictures or characters, for example, with company logos or the like. In addition to the advantage of a seamless coating, for the fiber jacket which is to be applied, the material used, the layer thickness, and the porosity can be kept variable and can be directly matched to customer wishes. The definable functional layering also contributes to this, and the functionality of the spunspray layer can be controlled, for example, with respect to its polarity, the activity of the boundary surface, or the intercalation of additives. In addition to the possible stabilization of folds, the filter element according to the invention can also be adjusted within a wide scope relating to the dirt holding capacity, the flow behavior, and the stability (cyclic flow fatigue).

Especially when a spunspray layer is being used as an upstream prefilter stage and downstream afterfilter stage, viewed in the direction of flow through the filter medium, located upstream and downstream of the medium, the chosen arrangement can be used as a so-called migration brake; i.e., dirt particles of the filter medium itself can be reliably controlled and captured by the respectively used filter medium material by way of the downstream spunspray layer so that the remaining circulation of the media remains protected from internal fouling portions of the filter.

The invention is detailed below using the drawings which are schematic and not to scale.

FIG. 1 shows a partial schematic cross section through a filter element which has been produced according to the invention, with a fiber jacket;

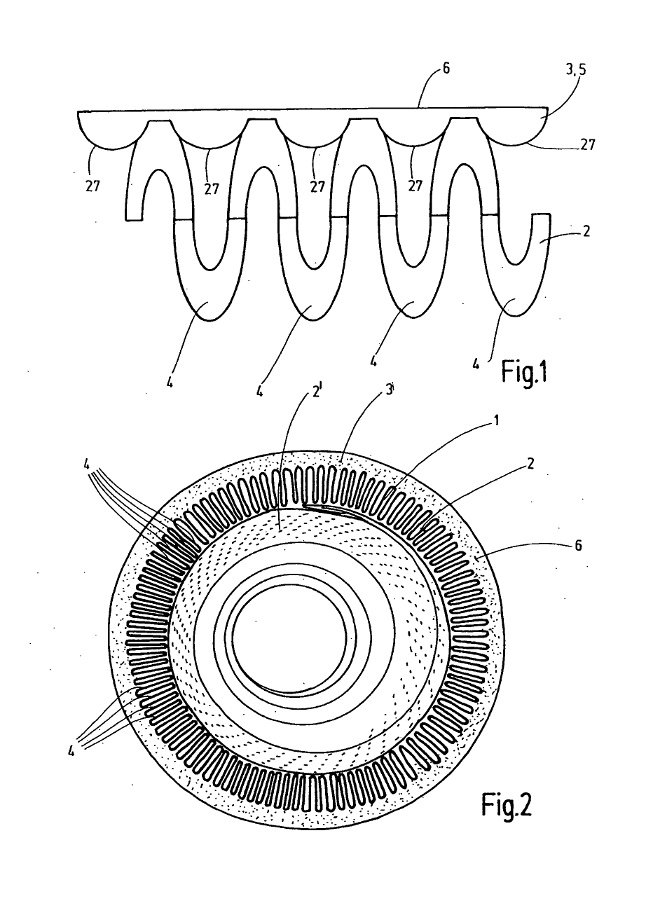

FIG. 2 shows in a top view a cross-sectional surface through a filter element which has been produced according to the invention, with a fiber jacket;

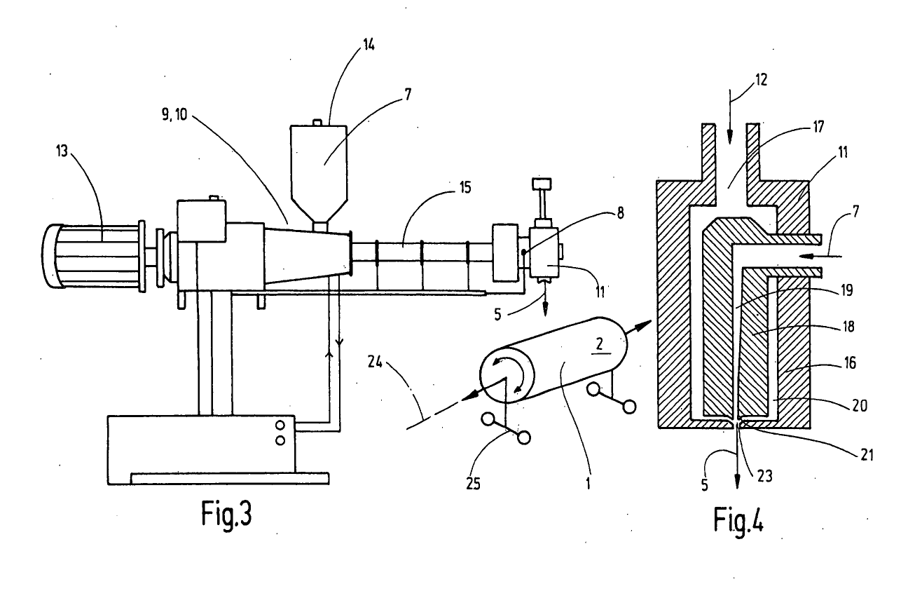

FIG. 3 shows a schematic of a device for carrying out a method according to the invention for producing the filter element;

FIG. 4 shows a schematic cross section through a binary filter for producing and for applying fibers to the filter medium of the filter element;

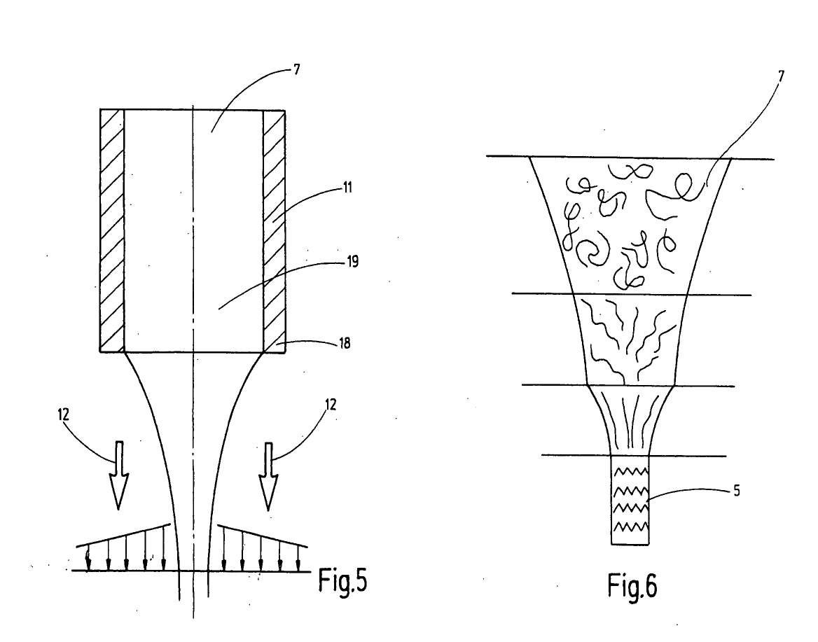

FIG. 5 shows a schematic of the jet constriction of a melt of the base material of the fibers which is emerging from the two-fluid nozzle in FIG. 4 under the influence of a transport air flow; and

FIG. 6 shows a schematic of the increasing alignment of the molecules in the base material for the fibers during and after passage through the two-fluid nozzle.

FIG. 1 shows in a partially schematically shown cross section a pleated filter medium 2 from a filter mat of conventional structure, which medium at regular intervals has individual folds 4 which are strung together sinusoidally. The filter medium 2, which is bent cylindrically proceeding from the plane layer as shown in FIG. 1, is part of a cylindrical filter element 1, which is shown in FIG. 2 and which is used for the filtration of a liquid or gaseous fluid. The filter medium 2 is built up in several layers and can conventionally be formed from a layering of several layers on top of one another, for example, formed from nonwoven and fiber materials as well as individual fabrics. Perforated grate pipes as well as perforated expanded metal jackets are used especially to form an inner support pipe 2′ for the filter medium. Preferably, a stainless steel or galvanized steel is used for the expanded metal jacket or the perforated grate pipe; but plastic solutions are also possible for the formation of the inner support pipe 2′. As FIG. 2 furthermore shows, the filter medium 2 with its fold edges adjoins the outer peripheral side of the support pipe 2′ on the inner peripheral side. The filter element, which is provided with a support pipe and two end caps, can then be interchangeably inserted into a conventional filter housing (not shown) in the conventional manner as a manageable filter apparatus.

A fiber layer is applied to the surface region 3 of the filter medium 2 in order to stabilize the position of the backs of the folds on the outside of the filter medium 2, which are located in FIG. 1 on the top edge of the folds 4 of the filter medium 2, with the outside in this case constituting the incident flow side of the unfiltered material for the filter element 1 even under high load by flow forces of the incident fluid medium flow. As shown in FIG. 2, the fiber layer here is wrapped in a blanket manner as a fiber jacket 6 around the outside of the cylindrical filter medium 2 in a roughly uniform layer thickness.

For the application of these individual fibers 5 of the fiber jacket 6, an application method shown schematically relative to FIG. 3 is used as well as an apparatus which consists essentially of an extruder device 9 with an integrated heating device 10, as well as an injection or spray device 8 in the form of a two-fluid nozzle 11 (compare FIG. 4).

In the illustrated exemplary embodiments, preferably a base material 7 made as a thermoplastic for producing the fibers 5 is used, with the granulate being supplied from the extruder device 9, which is driven by an electric motor 13 whose speed can be controlled. The plastic granulate is retained for this purpose in a storage tank 14 with a funnel-shaped bottom and is liquefied by means of the heating or melting device 10, for example, at a temperature of roughly 190° C. In a screw channel 15, which is conventional in extruder units, the plastic melt, as it continues to be heated to up to 285° C. and as its viscosity is reduced and as the pressure increases to roughly 35 bar, then travels to the injection and spray device 8 which is formed as a two-fluid nozzle 11, as is detailed in FIG. 4. The illustrated method process is preferably implemented continuously, but can also be carried out discontinuously with defined interruptions.

FIG. 4 shows a schematically illustrated longitudinal section through the two-fluid nozzle 11 for the formation of fibers 5 for purposes of application to the cylindrical filter element 1, which is shown schematically in FIG. 3, as is detailed in FIG. 2 in a cross section.

The two-fluid nozzle 11 is used essentially for mixing or combining a hot transport air flow 12 and the plastic melt of the base material 7. For this purpose, the two-fluid nozzle 11 is formed from a cylindrical first and outer nozzle body 16, which has an upper admission region or an admission opening 17 for the transport air flow 12. In the first or outer nozzle body 16, a second inner nozzle body 18 is centrally located, with the second nozzle body 18 in its interior having an admission channel 19 for the liquid base material 7. The base material 7 enters the admission channel 19 with a pressure of roughly 35 bar and a temperature of roughly 280° C., originating from the extruder device 9 and the screw channel 15 into the inner nozzle body 18. For this purpose, the nozzle body 18 has a channel duct which narrows at a conically acute angle, with the conically narrowing nozzle-like admission channel 19 narrowing by a multiple of the diameter of the blow air channel 20. The admission channel 19 on its free lower end has an exit opening 21 with a cone-like edge projecting into an exit opening 23 of the first nozzle body 16. The first nozzle body 16 in this respect surrounds the second nozzle body 18 around the entire periphery with a radial and axial distance with the formation of the blow air channel 20. The two adjacent exit openings 21 and 23 are arranged coaxially to the longitudinal axes of the pertinent nozzle bodies 18 and 16 respectively. The exit opening 21 with its edge of the inner nozzle body 18 is spaced apart from the exit opening 23 of the outer nozzle body 16 such that a reduced outflow cross section for the transport air flow 12 and thus an acceleration in the exit region of the liquid base material 7 arise.

The action of the accelerating transport air flow 12 as it leaves the two-fluid nozzle 11 is illustrated in FIG. 5, where a jet constriction of the plastic melt arises and, as shown especially by FIG. 6, the initially chaotically present molecules of the base material 7 are aligned successively in the spray jet as the respective fiber 5 is formed. This yields a fiber structure which has been stabilized by the inner molecule arrangement with very low optical double refraction values.

As FIG. 3 furthermore shows, for the uniform application of the fibers 5 which are forming from the two-fluid nozzle 11 for the pertinent fiber application, the intended filter element 1 with its outside of the filter medium 2 is inserted in a schematically shown device 25 such that it can be moved as it rotates according to the indicated double arrow around its longitudinal axis 24 in the region of the two-fluid nozzle 11, as a result of which a uniform application of fibers 5, but also an application of these fibers 5 to the folded filter medium 2 can take place, which application is controlled specifically in its mass distribution of the fibers 5. In this connection, the filter element 1 can also be moved, superimposing the rotational motion, coaxially to its longitudinal axis 24 by means of the device 25 also in the direction of the arrows which face away.

As FIG. 1 furthermore clearly illustrates, a fiber jacket 6, which is defined in any filter fineness, can be applied to the fold edges of the pleated filter medium 2. The base material 7, which is applied hot and which forms the fibers 5, also travels here between the folds 4, and a mass concentration can be possible between the folds 4 in a definable scope. The base material 7 in its heated form present as a melt has a tacky surface and, under certain circumstances and depending on the material of the filter medium 2 used, can also be joined adhesively to the fold edges or fold backs of the filter medium 2.

Moreover, when the base material 7 is cooling, a shrinkage process of the fibers 5 and of the fiber jacket 6 formed from them occurs, and for a filter jacket 6 which surrounds a filter medium 2, and especially a cylindrical filter medium 2 which is continuous in cross section, the process results in a transverse force being directed in the radial direction to the longitudinal axis 24 or to an interior of the filter element 1, as a result of which an at least reliable non-positive contact of the fibers 5 with the folds 4 is enabled.

As FIG. 1 furthermore illustrates, accumulations of the base material 7, which act as spacers 27, form between the folds 4 through indentations of the fibers 5. In this way, even under operating conditions of the filter element 1 which cause high mechanical stress, a reliable fixing and a protection of the folds 4 of the filter medium 2 are achieved. In the illustrated exemplary embodiments, the fibers 5 are aligned roughly transversely to the longitudinal alignment of the folds and therefore transversely to the longitudinal axis 24 of the filter element 1. In particular, a fiber application with alternating fiber application direction can, however, also be regarded here as especially advantageous since this solution leads to high burst and collapse compressive strengths for the entire filter element.

1. A method for producing a filter element (1) having a first filter medium (2), which has individual filter folds (4), and a second filter medium, which surrounds the filter folds (4) at least in regions in the manner of a mat-like filter jacket (6) that is composed of individual fibers (5), characterized in that to form the individual fibers (5), a solid base material is converted into a melt that is sprayed or injected onto the first filter medium (2) via at least one nozzle device (8) with the addition of a fluid transport flow in a directed fiber form such that the individual fibers (5) set at least after contacting the first filter medium (2) with the formation of the filter jacket (6), and that, for a successive mat build-up of the second filter medium (6) during the fiber application, the respective nozzle device (8) and the pleated first filter medium (2) execute a relative movement to one another and/or that the nozzle device (8) applies the fibers along the outside contour of the first filter medium (2) in definable spray or injection directions.

2. The method according to claim 1, characterized in that the fibers (5) are applied to the first filter medium (2) such that the applied fibers (5) keep the folds (4) in their position and/or form a prefilter or afterfilter stage for the filter medium (2).

3. The method according to claim 1, characterized in that the applied fibers (5) form at least one fiber material web between the folds (4).

4. The method according to claim 1, characterized in that the fibers (5) are applied superficially in a definable layer thickness to the first filter medium (2) as the filter jacket (6) forms.

5. The method according to claim 4, characterized in that the fibers (5) are applied in a layer thickness from roughly 2 mm to 6 mm to the first filter medium (2).

6. The method according to claim 4, characterized in that for the layer of the fibers (5) which form the second filter medium (6) a filter fineness lower or higher than for the first filter medium (2) is chosen as the prefilter and afterfilter stage is formed.

7. The method according to claim 1, characterized in that during a rotational movement of the filter element (1) which is made preferably cylindrical the fibers (5) are applied to the first filter medium (2).

8. The method according to claim 1, characterized in that the filter jacket (6) after its application to the first filter medium (2) shrinks in diameter and/or that the layer formed by the fibers (5) in the form of the filter jacket (6) is made seamless.

9. The method according to claim 1, characterized in that the fibers (5) are applied with a temperature higher than room temperature to the first filter medium (2).

10. The method according to claim 1, characterized in that the alignment of the fibers (5) is stipulated.

11. The method according to claim 10, characterized in that the fibers (5) are applied at roughly 20° to 90° transversely to the folds (4) of the first filter medium (2).

12. The method according to claim 1, characterized in that the fibers (5) are applied on the unfiltered material side and/or the filtrate side of the first filter medium (2) with the formation of a prefilter and afterfilter stage.

13. The method according to claim 1, characterized in that the fibers (5) are connected positively and/or non-positively to the other fibers of the filter medium (2) by a cement bond and/or by transverse forces directed at the folds (4) of the first filter medium (2).

14. The method according to claim 4, characterized in that the layer of fibers (5) contains supplementary filter agents such as silicates, oxides, carbonates, silica gel, polymers, glass, microbeads, or other porous substances with a low bulk density and/or is formed with a definable polarity.

15. The method according to claim 1 with at least the following further method steps:
liquefaction of a base material (7) of the fibers (5),
delivery of the liquid base material into an injection or spray device (8), and
application of the fibers (5) as a layer of defined thickness to the first filter medium (2).

16. The method according to claim 15, characterized in that the liquefaction and delivery of the base material (7) to the injection or spray device (8) takes place by an extruder device (9) with a heating device (10).

17. The method according to claim 15, characterized in that the injection or spray device (8) is formed by a two-fluid nozzle (11) which forms the fibers (5), the liquid base material (7) impressed onto a transport air flow (12) using the latter, the individual fiber molecules are directed and the fibers (5) are applied to the first filter medium (2).

18. The method according to claim 7, characterized in that during the application of the fibers (5) the first filter medium (2) is clamped in a device (25) which sets the first filter medium (2) into rotation with a definable angular velocity.

19. The method according to claim 1, characterized in that the fibers (5) are produced in a spunspray method and are applied to the first filter medium (2).

20. The method according to claim 1, characterized in that the method encompasses a trimming of the fiber jacket (6) and a subsequent application of pictures or characters to the fiber jacket (6) as well.
